(19) United States
(12) Patent Application Publication
(10) Pub. No.: US 2020/0227814 A1
(43) Pub. Date: Jul. 16, 2020

(54) CONFORMAL ANTENNA WITH INTEGRATED ELECTRONICS

(71) Applicant: The Boeing Company, Chicago, IL (US)

(72) Inventor: John E. Rogers, Owens Cross Roads, AL (US)

(21) Appl. No.: 16/246,327

(22) Filed: Jan. 11, 2019

(51) Int. Cl. H01Q 1/28; H01Q 21/00; H01Q 1/48; H01Q 21/06

(52) U.S. Cl. CPC H01Q 1/28; H01Q 21/064; H01Q 1/48; H01Q 21/0075

(57) ABSTRACT

Systems and methods for a conformal planar antenna is described herein. In one example, the antenna can include an antenna layer, a microstrip layer, an antenna ground plane layer, a stripline layer, and a buried electrical via. The antenna layer can include an antenna element. The microstrip layer can include a microstrip. The stripline layer can include a stripline. The buried electrical via can be electrically connected to the microstrip and the stripline.

### TECHNICAL FIELD

The disclosure relates generally to signal transmission and receiving systems and more specifically to an antenna that includes antenna element(s) and microstrip(s) electrically coupled to integrated electronics embedded within a composite substrate under the antenna.

### BACKGROUND

The exterior surfaces of aircraft and other vehicles often include curved surfaces. Unmanned aerial vehicles (UAVs), in particular, feature surfaces with low radii of curvature due to the compact size of UAVs. Regardless of the type of vehicle though, light weight antennas with low air drag for improved efficiency are beneficial. Low radar cross section is also desirable in certain applications. Thus, there is a need for antennas capable of conforming to curved surfaces that are efficient and provide minimal signal loss. Furthermore, there is a need for antennas with integrated electronics to minimize signal loss and reduce unwanted noise between an antenna and either a transmitter or receiver.

Existing planar patch and dipole antennas are inherently bandwidth-limited due to their resonant natures. Additionally, pin fed antennas are not recommended for conformal applications on curved surfaces due to the additional signal losses through electrical vias during conformal bending. Thus, improved conformal planar antennas are desirable.

### SUMMARY

Systems and methods are disclosed for an antenna. In a certain example, the antenna can include an antenna layer, a microstrip layer, an antenna ground plane layer, a stripline layer, a buried electrical via, and a reference ground plane. The antenna layer can include an antenna element. The microstrip layer can be disposed below the antenna layer and include a microstrip embedded within a composite substrate, where at least a portion of the microstrip is disposed below at least a portion of the antenna element. The antenna ground plane layer can be disposed below the microstrip layer and can include an opening. The stripline layer can be disposed below the antenna ground plane layer and can include a stripline. The buried electrical via can be disposed within the opening and connected to the microstrip and the stripline. The reference ground plane can be disposed below the stripline on the bottom of the composite substrate.

In another example, a method can be disclosed. The method can include forming a stripline layer that includes a stripline, forming an antenna ground plane layer, forming a microstrip layer that includes a microstrip embedded within a composite substrate, forming an antenna layer that includes an antenna element, forming an opening within the antenna ground plane layer, disposing a buried electrical via within the opening, and forming a reference ground plane on the bottom of the composite substrate.

The scope of the invention is defined by the claims, which are incorporated into this section by reference. A more complete understanding of the disclosure will be afforded to those skilled in the art, as well as a realization of additional advantages thereof, by a consideration of the following detailed description of one or more implementations. Reference will be made to the appended sheets of drawings that will first be described briefly.

### BRIEF DESCRIPTION OF THE DRAWINGS

FIG. 1 illustrates an aircraft in accordance with an example of the disclosure.

FIG. 2 illustrates a conformal antenna in accordance with an example of the disclosure.

FIG. 3 illustrates a top see-through view of a conformal antenna in accordance with an example of the disclosure.

FIG. 4 illustrates a cutaway view of a conformal antenna in accordance with an example of the disclosure.

FIGS. 5A and 5B illustrates views of portions of the conformal antenna in accordance with examples of the disclosure.

FIGS. 6A-E are illustrations of the performance of conformal antennas in accordance with examples of the disclosure.

FIGS. 7 and 8 illustrates cutaway views of a technique for manufacturing the conformal antenna in accordance with examples of the disclosure.

Examples of the disclosure and their advantages are best understood by referring to the detailed description that follows. It should be appreciated that like reference numerals are used to identify like elements illustrated in one or more of the figures.

### DETAILED DESCRIPTION

Various examples of conformal antennas are described herein. Such radio frequency (RF) antenna assemblies can include an antenna layer (disposed above a first dielectric layer), a microstrip layer (disposed below a second dielectric layer and above a third dielectric layer), an antenna ground plane layer (disposed below a fourth dielectric layer and above a fifth dielectric layer), a stripline layer (disposed above a sixth dielectric layer), an electrical via (disposed within the third and fourth dielectric layers), and a reference ground plane (disposed below the sixth dielectric layer). Dielectric layers can alternatively be referred to as the composite substrate. The antenna layer can include an antenna element. The microstrip layer can be below the antenna layer and include a microstrip embedded within the composite substrate. The antenna ground plane layer can be below the microstrip layer and include an opening. The stripline layer can be below the antenna ground plane layer and include a stripline. The electrical via can be disposed within the opening and electrically short the microstrip to the stripline. The reference ground plane can be below the stripline layer.

In certain examples, the antenna element can include one or more inclusive slots electrically coupled to the microstrip. The use of electrically coupled feed elements allows for the microstrip and antenna element to be coupled without electrical vias, simplifying fabrication. Additionally, such planar antennas can additionally include integrated electronics embedded within one or more layers of the composite substrate below the antenna.

The antenna of various examples described herein includes an embedded RF microstrip feed network electrically coupled to an antenna ground plane. The antenna ground plane, which is electrically shorted to a reference ground plane, can minimize changes of the antenna's electrical behavior due to conductive surfaces within the environment around the antenna (e.g., due to aluminum or carbon fiber aircraft skins disposed proximate the antenna). Additionally, the electrically coupled antenna elements allow for simplified feeding of the antenna, simplified fabrication, planar arraying, and reduction of antenna failure rates resulting from flexure. Electrical coupling of the various layers can be performed through thin RF dielectrics by the electrically coupled antenna elements.

The integrated electronics of the antenna can, in certain examples, be located underneath the antenna ground plane. The antenna ground plane can be electrically shorted to the reference ground plane. An embedded microstrip to stripline transition can electrically connect the antenna to the integrated electronics.

In certain examples, cross polarization resulting from the electrically coupled antenna elements described herein can allow for increased bandwidth and, thus, reduced signal loss from a transmitter to a receiver due to antenna misalignment.

For the purposes of this disclosure, “electrically coupled” can refer to configurations where an element (e.g., component of the antenna) electrically affects at least another element. That is, for example, a current and/or signal can be passed between the two elements that are “electrically coupled.” In certain examples, the current and/or signal can be modified by one of the elements, or each element can be merely a conduit for the current and/or signal.

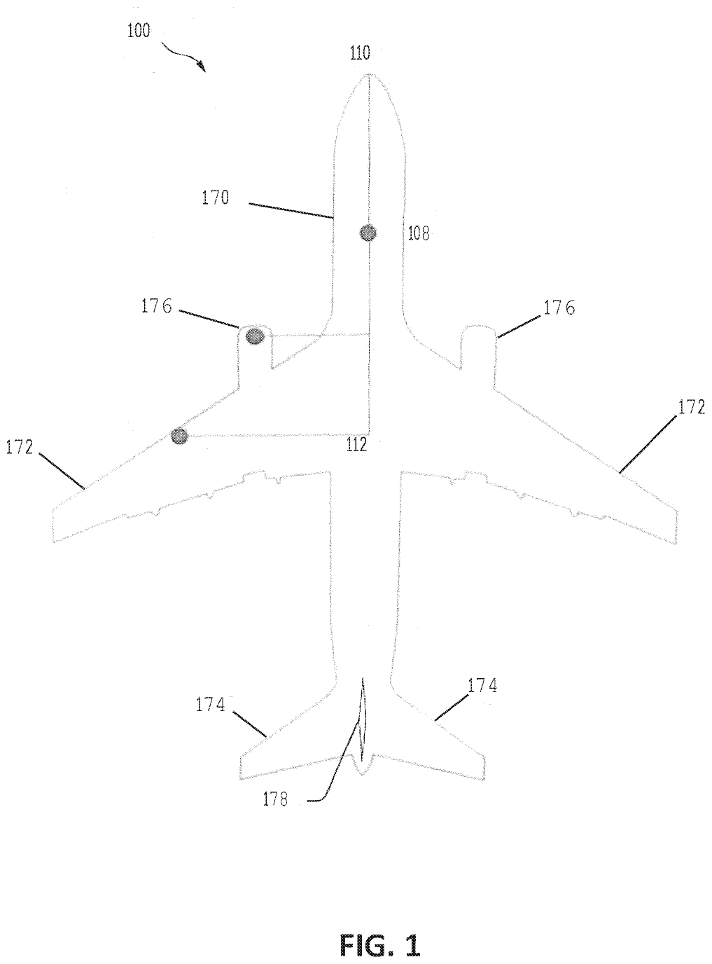

FIG. 1 illustrates an aircraft in accordance with an example of the disclosure. The aircraft 100 of FIG. 1 can include fuselage 170, wings 172, horizontal stabilizers 174, aircraft engines 176, and vertical stabilizer 178. Additionally, aircraft 100 can include communications electronics 110, controller 108, and communications channel 112.

Aircraft 100 described in FIG. 1 is exemplary and it is appreciated that in other examples, aircraft 100 can include more or less components or include alternate configurations. Additionally, concepts described herein can be extended to other aircraft such as helicopters, drones, missiles, etc.

Communications electronics 110 can be electronics for communication between aircraft 100 and other mobile or immobile structures (e.g., other aircrafts, vehicles, buildings, satellites, or other such structures). Communications electronics 110 can be disposed within fuselage 170, wings 172, horizontal stabilizers 174, vertical stabilizer 178, and/or another portion of aircraft 100. Communications electronics 110 can include an antenna for sending and receiving signals. Examples of various antenna configurations are described herein.

Communications channel 112 can allow for communications between controller 108 and various other systems of aircraft 100. Accordingly, communications channel 112 can link various components of aircraft 100 to the controller 108. Communications channel 112 can, for example, be either a wired or a wireless communications system.

Controller 108 can include, for example, a microprocessor, a microcontroller, a signal processing device, a memory storage device, and/or any additional devices to perform any of the various operations described herein. In various examples, controller 108 and/or its associated operations can be implemented as a single device or multiple connected devices (e.g., communicatively linked through wired or wireless connections such as communications channel 112) to collectively constitute controller 108.

Controller 108 can include one or more memory components or devices to store data and information. The memory can include volatile and non-volatile memory. Examples of such memory include RAM (Random Access Memory), ROM (Read-Only Memory), EEPROM (Electrically-Erasable Read-Only Memory), flash memory, or other types of memory. In certain examples, controller 108 can be adapted to execute instructions stored within the memory to perform various methods and processes described herein, including implementation and execution of control algorithms responsive to sensor and/or operator (e.g., flight crew) inputs.

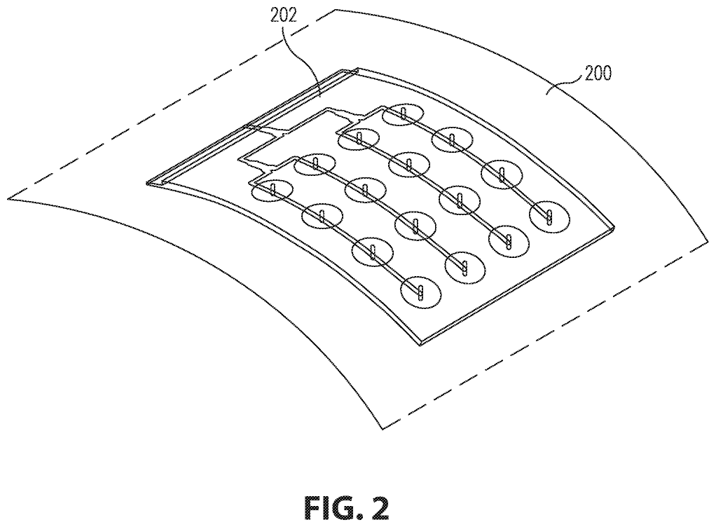

FIG. 2 illustrates a conformal antenna in accordance with an example of the disclosure. Antenna 202 of FIG. 2 can be disposed on a surface 200 of an aircraft. In certain examples, surface 200 can be a curved surface. Antenna 202 can reliably conform to such a curved surface.

For example, unmanned aerial vehicles (UAVs) have conformal surfaces with low radii of curvature. Antenna 202 can be disposed on such surfaces and conform to the curvature without failure of antenna elements, resulting in an antenna with low air drag and low radar cross sections. Antenna 202 can include one or more of the features described herein to allow for effective transmitting and receiving of signals while conforming to a curved surface.

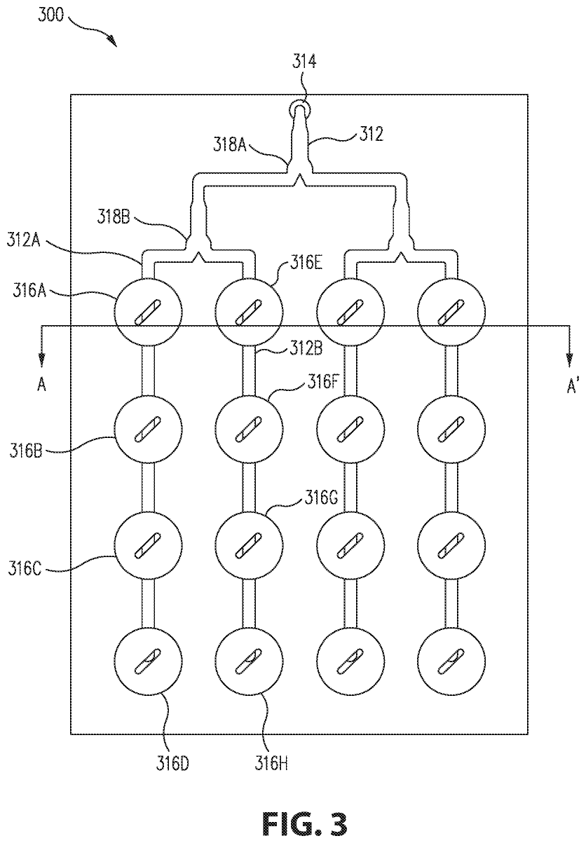

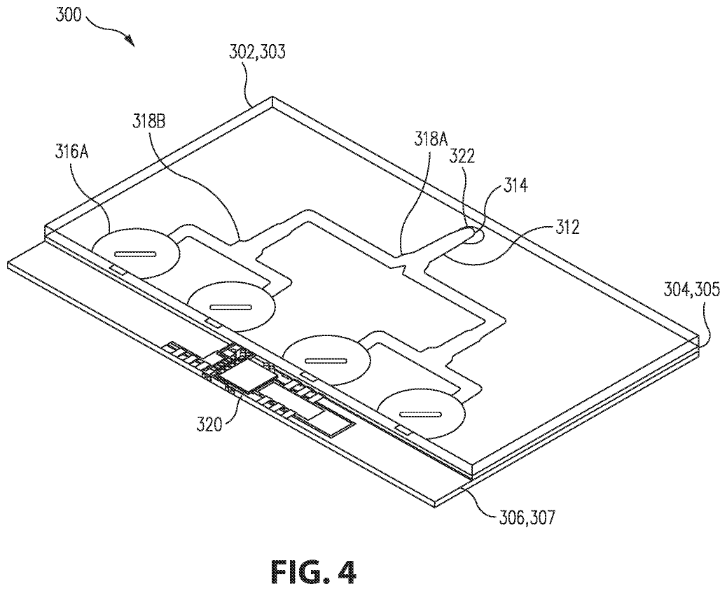

FIG. 3 illustrates a top see-through view of a conformal antenna in accordance with an example of the disclosure. FIG. 3 illustrates conformal planar antenna 300 or portion thereof. FIG. 3 shows a see-through top view of antenna 300 showing antenna layer 316 and microstrip layer 312 (positioning of the layers is illustrated in FIG. 4). Antenna layer 316 includes antenna elements 316A-H as well as other antenna elements. Microstrip layer 312 can include microstrip 312 electrically connected to buried electrical via 314.

Antenna elements 316A-H can be antenna elements with a conductive element and a slot. As shown in FIG. 3, the conductive element of antenna elements 316A-H can include a substantially circular outer perimeter of a diameter appropriate for the desired operating frequency. Other embodiments can include antenna elements of other shapes.

Furthermore, antenna elements 316A-H can include a slot. The slot can be any appropriate shape, including a substantially rectangular shape (with, possibly, rounded ends as shown in FIG. 3) that includes a slot length (e.g., major dimension) and slot width (e.g., minor dimension). The length and width of the slot can vary depending on desired operating frequency. In general, the antenna elements 316A-H can be shaped and/or can include dimensions appropriate for the application.

In certain examples, the configuration of antenna elements 316A-H (e.g., the shape and/or slot configuration) can cause circular polarization of current signals. That is, each antenna element 316A-H can cause effective circular rotation of the current of electrical signals transmitted by the respective antenna element. Circular polarization of electrical signals can lower power loss and, thus, improve signals transmission or reception.

In various examples, antenna elements 316A-H and other antenna elements can be arranged in an array such as a grid array (e.g., a 4×4 array as shown in FIG. 3). Various examples can arrange such arrays in a plurality of different shapes, sizes, and configurations.

Thus, an electrical power signal can be transmitted or received through one or more of antenna elements 316A-H (e.g., passed through an opening or through portions thereof). Such electrical power signals can be passed through microstrip 312 before transmission by or after being received by antenna elements 316A-H, respectively. Accordingly, in certain examples, at least a portion of antenna elements 316A-H are disposed over microstrip 312. In certain examples, antenna elements 316A-H can be referred to as surface elements while other examples can embed antenna elements 316A-H within a composite substrate.

Microstrip 312 can be a conductive element or strip. An electrical power signal can be supplied to microstrip 312 by, for example, embedded electronics of antenna 300, as described herein. Microstrip 312 can be configured to power each of the antenna elements of antenna 300. Thus, microstrip 312 can include power dividers 318A and 318B to allow microstrip 312 to split from a single strip to multiple strips at certain portions of microstrip 312. Multiple power dividers, as illustrated in FIG. 3, can be used to more evenly split power.

Portions of microstrip 312 can be disposed below antenna elements 316A-H and electrically couple to the antenna elements. To transmit signals, an electrical power signal can be supplied to microstrip 312. The current is then electrically coupled to the antenna elements. Antenna elements 316A-H can cause the current coupled from microstrip 312 to circularly rotate within at least a portion of microstrip 312 and/or one or more antenna elements due to the electrical coupling. Such current can accordingly be electrically coupled to free-space (e.g., transmit) to other antennas (e.g., receiving antennas). Similarly, signals can be received by antenna elements 316A-H. Signals received can then be electrically coupled to microstrip 312, which can then provide the signals to, for example, a receiver.

Microstrip 312 can be electrically connected to electrical via 314. Electrical via 314 can electrically connect microstrip 312 to embedded electronics disposed on a different layer of antenna 300 (e.g., through stripline 328). Such a configuration can be further described in FIG. 4.

FIG. 4 illustrates a cutaway view of a conformal antenna in accordance with an example of the disclosure. The cutaway view illustrated in FIG. 4 can be at least partially along plane AA′ shown in FIG. 3. Further features of antenna 300 can be illustrated by FIG. 4. For example, as shown in FIG. 4, antenna 300 can include antenna layer 316 that includes antenna elements 316A-H, microstrip layer 312 that includes microstrip 312, and the fifth dielectric layer 306 exposing the embedded electronics.

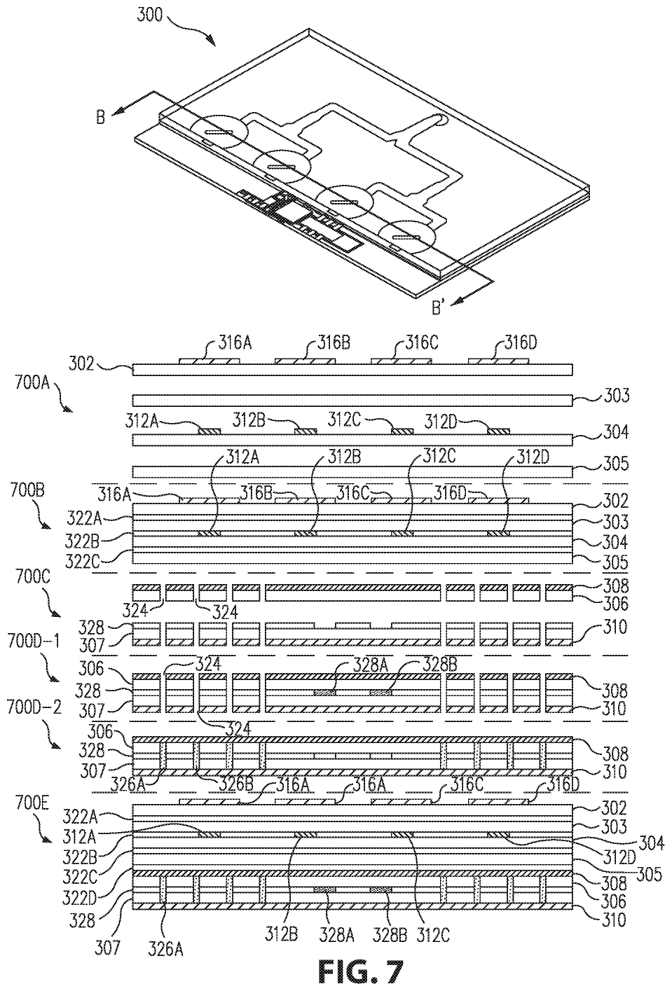

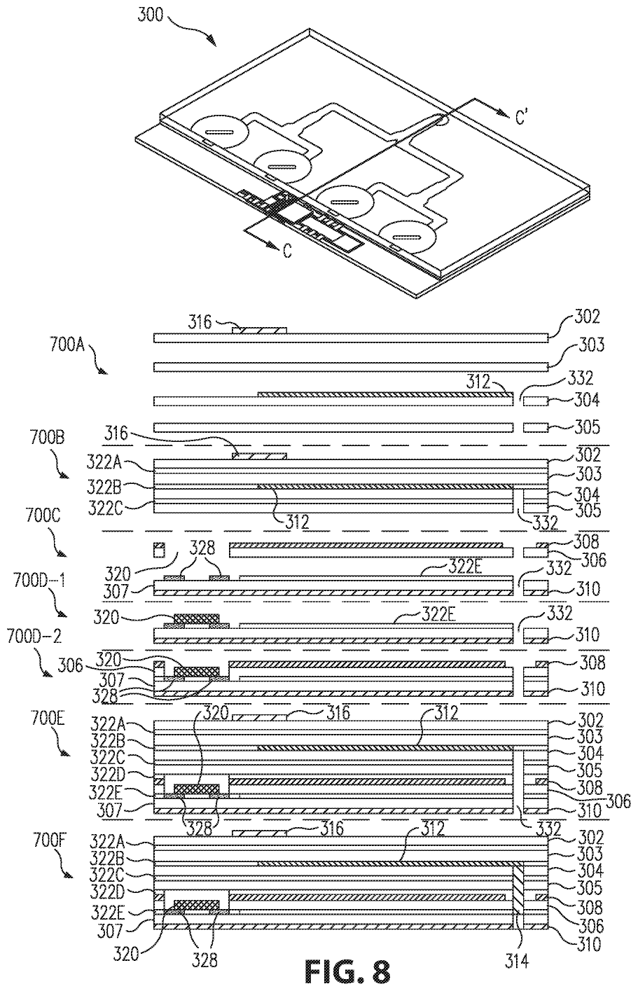

Third dielectric layer 304 and fourth dielectric layer 305 define at least a portion of opening 322. Electrical via 314 can be disposed within opening 322 and electrically isolated from antenna ground plane 308 (shown in FIGS. 7 and 8). Antenna 300 described herein can include conductive elements such as microstrips or striplines on multiple layers of antenna 300 (e.g., third dielectric layer 304 and fifth dielectric layer 306).

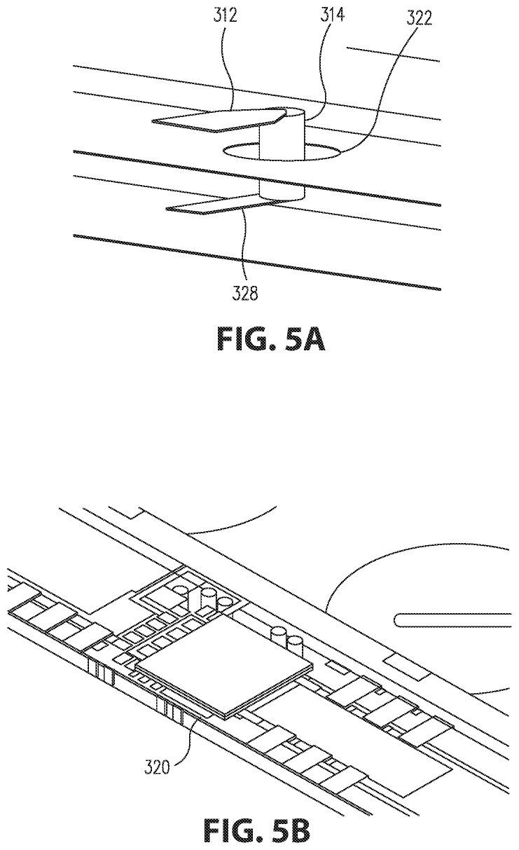

Including such conductive elements on multiple layers of antenna 300 can allow for the microstrip to be electrically connected to embedded electronics 320. Such a configuration can additionally allow for embedded electronics 320 to be disposed below at least a portion of the microstrip (e.g., microstrip 312 shown in FIG. 5A) or antenna elements and, thus, allow for a conformal planar antenna with a lower form factor.

Such a configuration can be further illustrated in FIGS. 5A and 5B. FIGS. 5A and 5B illustrates views of portions of the planar antenna in accordance with examples of the disclosure.

As shown in FIG. 5A, microstrip 312 can be disposed on third dielectric layer 304. Stripline 328 can be disposed on fifth dielectric layer 306. Microstrip 312 and stripline 328 can be electrically shorted by electrical via 314 disposed within opening 322. Opening 322 can be disposed within both of third dielectric layer 304 and fourth dielectric layer 305. Stripline 328 can be an electrically conductive element.

Furthermore, embedded electronics 320 can be disposed on the sixth dielectric layer 307, the same layer that stripline 328 is disposed on. Embedded electronics 320 can be connected to stripline 328 to be electrically connected to electrical via 314, microstrip 312, and/or antenna elements 316A-H. Embedded electronics 320 can include one or more processors, memory (e.g., non-transitory and/or transitory memory), resistors, capacitors, cooling components, and/or other electronics configured to operate antenna 300. Embedded electronics 320 can be configured to operate antenna 300. In certain examples, embedded electronics 320 can be disposed within a further opening within the layer (e.g., fifth dielectric layer 306).

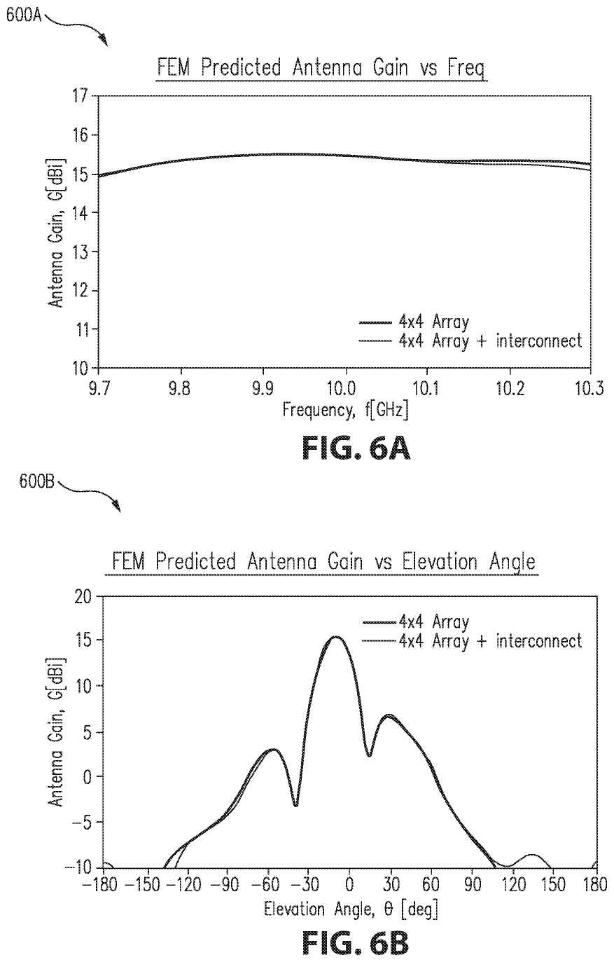

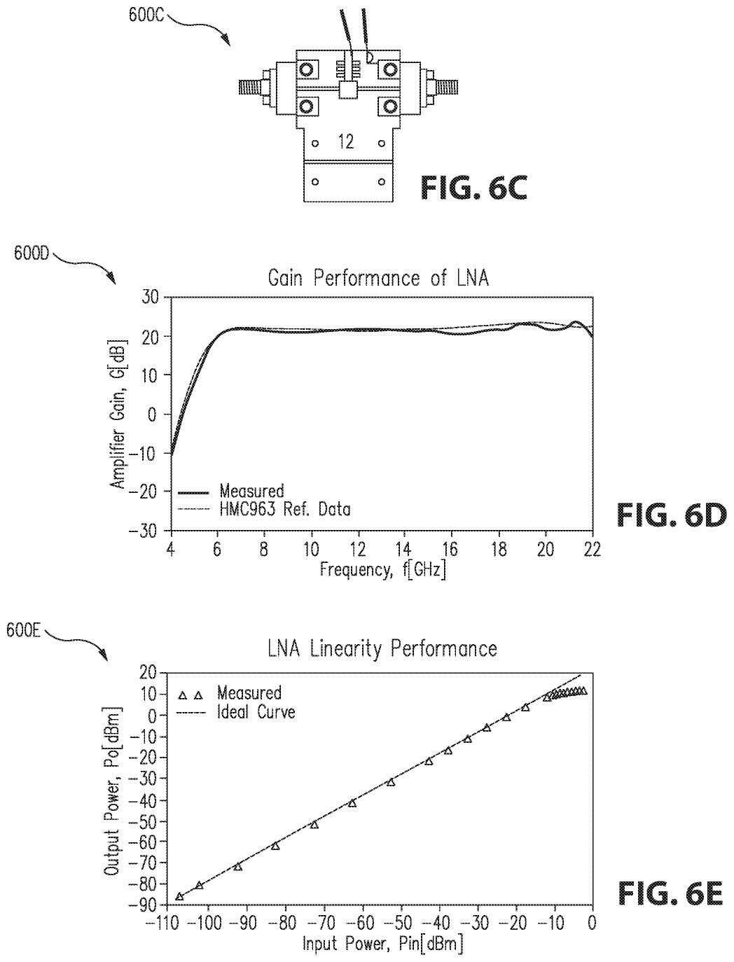

FIGS. 6A-E are illustrations of the performance of conformal antennas in accordance with examples of the disclosure. FIGS. 6A and 6B illustrate expected performance through analysis of a finite element model to predict the performance of an antenna with a 4×4 array of antenna elements that are configured to operate near 10 GHz. Both arrays with and without an embedded electronics interconnect were analyzed. As shown in charts 600A and 600B, performance of the two arrays are nearly identical with a predicted gain of 15.5 dBi for both arrays.

Low noise amplifier (LNA) 600C is shown in FIG. 6C and the performance of LNA 600C when utilized as embedded electronics within a conformal antenna is illustrated in FIGS. 6D and 6E. LNA 600C can be an example of integrated electronics embedded within a portion of antenna 300, as described herein. LNA 600C can be a packaged low noise amplifier configured to be attached within the composite substrate. LNA 600C can be configured to be attached using a printed assembly method or more traditional solder paste method. While LNA 600C includes the features described herein, other examples of embedded electronics can include other characteristics, features, performance, and/or configurations.

As shown in chart 600D, the gain performance of LNA 600C with a printed assembly method matches well with the data provided by the vendor for performance of LNA 600C up to, at least, 22 GHz. Thus, LNA 600C can be appropriately used as embedded electronics. Furthermore, as shown in chart 600E, LNA 600C has measurable output down to ˜110 dBm.

FIGS. 7 and 8 illustrates cutaway views of a technique for manufacturing the conformal antenna in accordance with examples of the disclosure. FIG. 7 illustrates manufacturing conformal antenna 300 from a cutaway perspective along plane BB′. FIG. 8 illustrates manufacturing conformal antenna 300 from a cutaway perspective along plane CC′. FIGS. 7 and 8 illustrate steps 700A-F used in the manufacture of conformal antennas. However, other examples can include additional or fewer steps to that shown in FIGS. 7 and 8.

Antenna 300 shown in FIGS. 7 and 8 can include a plurality of ground planes such as antenna ground plane 308 and reference ground plane 310. Both antenna ground plane 308 and reference ground plane 310 can be disposed below microstrip 312 (which can divide into microstrip portions 312A-D underneath antenna elements 316A-D). Embedded electronics 320 can be disposed between antenna ground plane 308 and reference ground plane 310.

Accordingly, antenna ground plane 308 can minimize any changes in electrical behavior of antenna 300 due to embedded electronics 320 and other portions of antenna 300 below antenna ground plane 308. Reference ground plane 310 can minimize any changes in electrical behavior of antenna 300 due to conductive surfaces located proximate antenna 300 (e.g., changes due to the presence of conductive surfaces such as the aluminum and/or composite surfaces of aircrafts). Ground planes 308 and 310 are electrically shorted by electrical vias 326.

In step 700A, antenna element 316 can be formed (e.g., patterned, deposited, and/or printed) on first dielectric layer 302. Microstrip 312 can be formed on third dielectric layer 304. Microstrips of antenna 300 can be electrically conductive elements formed (e.g., patterned, deposited, and/or printed) on or embedded within the dielectric layers or a portion thereof.

Additionally, opening 332 can be formed within the third dielectric layer 304 and fourth dielectric layer 305. Opening 332 can be formed during initial forming of such layers (e.g., deposition can leave such an opening) or can be formed in a secondary operation (e.g., opening 332 can be etched).

In step 700B, the portions of first dielectric layer 302, second dielectric layer 303, third dielectric layer 304, and fourth dielectric layer 305 can be laminated together. For example, first dielectric layer 302, second dielectric layer 303, third dielectric layer 304, and fourth dielectric layer 305 can be laminated together with adhesives 322A, 322B, and 322C placed between the four dielectric layers. In various other examples, any appropriate adhesive that holds the various layers described herein can be utilized.

In step 700C, antenna ground plane 308, fifth dielectric layer 306, and reference ground plane 310 can be formed by the techniques described herein. Furthermore, sixth dielectric layer 307 is configured to be disposed between fifth dielectric layer 306 and the reference ground plane 310.

Reference ground plane 310 can include a conductive ground plane element. A similar conductive element can be included within antenna ground plane 308. Fifth dielectric layer 306 can additionally include stripline 328.

Openings 324, as well as other openings can be formed in fifth dielectric layer 306 and sixth dielectric layer 307 by the techniques described herein. Openings 324 can be configured to receive electrical vias 326 to electrically short ground planes 308 and 310.

In step 700D, antenna ground plane 308, fifth dielectric layer 306, sixth dielectric layer 307, and reference ground plane 308 can be bonded together through techniques as described herein. In step 700D-1, embedded electronics 320 can be electrically connected to stripline 328 by, for example, placing, soldering, or other appropriate techniques.

In step 700D-2, antenna ground plane 308 can be disposed on top of fifth dielectric layer 306. Fifth dielectric layer 306 can be disposed on top of sixth dielectric layer 307. For example, fifth dielectric layer 306 can be laminated to sixth dielectric layer 307 with adhesive 322E. Additionally, in step 700D-2, electrical vias 326 can be formed within openings 324 through a deposition or filling operation. The deposition or filling of electrical vias 326 can be through deposition, adhesive, or through another appropriate technique.

In step 700E, the top portion formed in steps 700A and 700B and the bottom portion formed in steps 700C and 700D can be bonded together. For example, the top and bottom portions can be bonded through adhesive 322D and/or other appropriate techniques. In step 700F, electrical via 314 can be formed within opening 332 to electrically connect microstrip 312, stripline 328, antenna ground plane 308, and reference ground plane 310.

Thus, the process described in FIGS. 7 and 8 can be performed to manufacture the conformal planar antennas described herein. Such a process can provide a simple manufacturing process for the antennas as all layers are disposed in a stacked manner, allowing for manufacture of the antennas through simple processes such as deposition, etching, patterning, printing, and/or adhering of two or more layers.

Examples described above illustrate but do not limit the invention. It should also be understood that numerous modifications and variations are possible in accordance with the principles of the present invention. Accordingly, the scope of the invention is defined only by the following claims.

What is claimed is:

1. An antenna comprising:
an antenna layer comprising an antenna element;
a microstrip layer disposed below the antenna layer and comprising a microstrip embedded within a composite substrate, wherein at least a portion of the microstrip is disposed below at least a portion of the antenna element;
an antenna ground plane layer disposed below the microstrip layer and comprising an opening;
a stripline layer disposed below the antenna ground plane layer and comprising a stripline; and
a buried electrical via disposed within the opening and connected to the microstrip and the stripline.

2. The antenna of claim 1, wherein the stripline layer further comprises embedded electronics electrically connected to the stripline.

3. The antenna of claim 1, further comprising a reference ground plane layer disposed below the stripline layer.

4. The antenna of claim 3, wherein the buried electrical via is disposed above the reference ground plane layer.

5. The antenna of claim 3, further comprising a ground plane electrical via connected to the antenna ground plane layer and the reference ground plane layer.

6. The antenna of claim 1, wherein the antenna element comprises a slot disposed over the portion of the microstrip.

7. The antenna of claim 6, wherein a major length of the slot is disposed at a substantially 45 degree angle to a major length direction of the microstrip.

8. The antenna of claim 1, wherein the antenna element comprises a substantially circular outer perimeter.

9. The antenna of claim 1, further comprising:
a first dielectric layer disposed below the antenna layer;
a third dielectric layer disposed below the microstrip layer;
a fifth dielectric layer disposed below the antenna ground plane layer; and
a sixth dielectric layer disposed below the stripline layer.

10. The antenna of claim 1, wherein the antenna layer, the microstrip layer, the antenna ground plane layer, and the stripline layer are substantially planar.

11. The antenna of claim 1, wherein the antenna layer comprises a plurality of antenna elements and at least a portion of the microstrip is disposed below at least one of the plurality of antenna elements.

12. The antenna of claim 11, wherein the plurality of antenna elements is arranged in at least a two by two grid comprising a first side and a second side.

13. The antenna of claim 12, wherein the microstrip comprises a first strip portion, a second strip portion, and a power divider coupling the first strip portion to the second strip portion, and wherein the first strip portion is disposed under the first side of the two by two grid and the second strip portion is disposed under the second side of the two by two grid.

14. An aircraft comprising the antenna of claim 1, wherein the aircraft further comprises:
a fuselage; and
a wing, wherein the antenna is coupled to the fuselage and/or the wing.

15. The aircraft of claim 14, wherein the antenna is disposed on a curved surface of the fuselage and/or the wing.

16. A method comprising:
forming a stripline layer comprising a stripline;
forming an antenna ground plane layer;
forming a microstrip layer comprising a microstrip embedded within a composite substrate;
forming an antenna layer comprising an antenna element;
forming an opening within the antenna ground plane layer; and
disposing a buried electrical via within the opening.

17. The method of claim 16, wherein the forming the stripline layer comprises:
printing and/or etching the stripline;
printing and/or etching the opening within the stripline layer; and
disposing embedded electronics within the electronics opening, wherein the embedded electronics are electrically connected to the stripline.

18. The method of claim 16, further comprising:
forming a reference ground plane layer.

19. The method of claim 18, further comprising:
disposing the stripline layer above the reference ground plane layer;
disposing the antenna ground plane layer above the stripline layer;
disposing the microstrip layer above the antenna ground plane layer; and
disposing the antenna layer above the microstrip layer.

20. The method of claim 19, further comprising:
forming a ground plane opening within at least the antenna ground plane layer and the reference ground plane layer; and
forming a ground plane electrical via within the connected ground plane opening.
